(19) United States
(12) Patent Application Publication
(10) Pub. No.: US 2025/0323780 A1
(43) Pub. Date: Oct. 16, 2025

(54) Privacy-Preserving Queries Using On-Device Model

(71) Applicant: Apple Inc., Cupertino, CA (US)

(72) Inventors: Rehan Rishi, San Francisco, CA (US); Haluk N. Tokgozoglu, New York City, NY (US); Hazi Malang Riyaaz Shaik, Sunnyvale, CA (US); Marco Zuliani, San Jose, CA (US); Chandrasekar Venkataraman, Los Altos, CA (US); Muqun Li, Long Island City, NY (US)

(21) Appl. No.: 19/173,410

(22) Filed: Apr. 8, 2025

Related U.S. Application Data
(60) Provisional application No. 63/633,460, filed on Apr. 12, 2024.

(51) Int. Cl. H04L 9/08

(52) U.S. Cl. CPC H04L 9/0825

(57) ABSTRACT

Techniques are disclosed relating to privacy-preserving query processing using on-device models. A device storing a query processing model receives a query. The device sends, based on the query, information requests according to privacy protocols, where the information request is encrypted such that a plaintext version of the given information request is not accessible to the server. The device then receives from the server one or more information responses to the information request that includes response objects generated according to the privacy protocols and are not accessible to the server. The device decrypts, using a cryptographic key, response objects that are received as part of the one or more information responses, generates, using the query processing model and the decrypted response objects, a result for the query. The device then outputs the generated result.

The present application claims priority to U.S. Provisional App. No. 63/633,460, entitled “Privacy-Preserving Queries Using On-Device Model,” filed Apr. 12, 2024, the disclosure of which is incorporated by reference herein in its entirety.

### BACKGROUND

### Technical Field

This disclosure relates generally to providing responses to user queries, and, more specifically, to providing responses to queries using an on-device model and private information retrieval from servers.

### Description of the Related Art

Language models are designed to understand, generate, and predict patterns within human language. These models leverage algorithms and techniques to process textual training data and grasp the nuances of syntax, semantics, and language structures. By analyzing sequences of words and their relationships, language models can generate coherent text, facilitate language translation, provide summaries, answer questions, and execute various language-related tasks. Language models should generally provide recommendations that reflect user preferences as accurately as possible. Language models have extensive applications across industries due to their ability to both process large amounts of data and understand human language. Example language model-based tools include machine translation software, chatbots and virtual assistants, content generation and writing assistance tools, automated content creation tools, etc.

Users make use of such language models on a variety of computing devices, including mobile computing devices. These devices send requests and/or data to servers, where the language model typically resides due to size. The model can interpret and process incoming information to generate appropriate responses, which are then relayed to the requesting devices. Language models are commonly trained on textual data-which may run to terabytes of information-prior to being installed on a server and servicing user requests.

### BRIEF DESCRIPTION OF THE DRAWINGS

FIG. 1 is a block diagram of one embodiment of a system for generating results for input queries to a language model.

FIG. 2 is a block diagram of one embodiment of an on-device query processing model that services information retrieval queries.

FIG. 3 is a block diagram of one embodiment of a privacy protocol performed by the device.

FIG. 4 is a block diagram of one embodiment of a server that is configured to communicate with devices according to one or more privacy protocols.

FIG. 5A is a block diagram of one embodiment of a system for generating a response to a query using a specific on-device model implementation.

FIG. 5B is a block diagram of one embodiment of a system for generating a response to a query using a two-round communication between the device and the server.

FIG. 6A is a block diagram of one embodiment of a system for generating a response to a query of a particular device using data from the device and data from a server.

FIG. 6B is a block diagram of one embodiment of a system for generating a response to a query of a particular device using data from two different servers.

FIG. 7 is a flow diagram of one embodiment of a method performed by a computing device for servicing queries.

FIG. 8 is a flow diagram of one embodiment of a method performed by a computer server for servicing queries.

FIGS. 9A-F are block diagrams illustrating examples of an application programing interface implementing functionality described herein.

### DETAILED DESCRIPTION

In some cases, a user may desire to utilize a language model on a topic of a sensitive nature. Examples include sharing symptoms with a health assistant to receive a possible diagnosis, sending a location and dates to a travel assistant to generate a travel itinerary, performing artificial-intelligence-assisted editing on personal photos, sharing a device screenshot to a voice assistant to receive assistive audio for the screenshot, etc. More generally, a user may simply not wish to disseminate information about queries made to servers. Accordingly, some platforms and users may wish to prioritize user privacy by not disseminating users' sensitive data to potentially untrusted servers.

One possible method to prevent sensitive user information from leaving a client device is to store and train the entire language model on the client device, and then have the client device generate recommendations without server involvement. But the information needed to store the entire model may be extremely voluminous, and thus it may not be feasible for typical client devices such as smartphones to generate recommendations on such a scale. Furthermore, the training and retrieval of data may overly tax the memory or processing power of client devices, which may be already using their resources to execute other software for the user. While it may instead be possible to download a smaller catalog, the resulting recommendations would not benefit from the same quantity of information and may thus be of lower quality. The inventors have thus recognized these deficiencies and the need for generating high-quality recommendations that utilize the full extent of server-side information while preserving the privacy of users' sensitive information.

The inventors have realized that this conflict can be addressed by the use of privacy protocols to communicate between devices and servers. As used herein, a “privacy protocol” or “privacy retrieval protocol” is an algorithm that permits retrieval of information from a device in a manner that seeks to limit the likelihood that the device can learn the identity of the requested data. Privacy protocols include protocols based on privacy-preserving computation techniques such as homomorphic encryption, Secure Multi-Party Computation (MPC), functional encryption, differential privacy, federated learning, oblivious random access memory (RAM), and the like. One example class of privacy protocols is Private Information Retrieval (PIR) protocols. PIR protocols allow for key-value retrievals from a data store using encrypted parameters, but without the data store learning the values of those parameters (thus providing privacy). Other privacy protocols may enable additional types of computations, such as numeric computations, to be performed on a computer system using the computer system's own data, without the computer system learning the values of data included in requests to that server. APPLE's proprietary Private Encrypted Compute (PEC) is one example of another privacy protocol. The present disclosure explicitly contemplates operations that combine multiple types of privacy protocols as well as individual privacy protocols with more than a single type of privacy-preserving technique. For example, a given privacy protocol may utilize both functional encryption and homomorphic encryption.

Yet the present inventors have recognized that there may still be issues with the traditional use of privacy protocols. As is understood, unencrypted messages may be referred to as being in plaintext, while encrypted messages may be referred to as being in ciphertext. Operations on ciphertext can thus be referred to as being performed in ciphertext space. In typical implementations, many of the computations performed by privacy protocols occur on the server and are performed in the ciphertext space. But these computations, which are already expensive to perform in plaintext space, may become even more expensive when homomorphic operations are involved. Thus, typical implementations of privacy protocols are relatively taxing on the server.

To avoid this server overhead, the inventors propose performing a portion of privacy protocol on the requesting-device-side using an on-device model, while performing remaining portions of the privacy protocol on the server. This division of labor can be set such that the portions of the privacy protocol performed on the server merely retrieve raw data. In this manner, the server may be considered to be analogous to a database that has additional privacy capabilities, as the server does not know the plaintext values of the queries it receives, or the data it returns. The proposed paradigm advantageously preserves user privacy by using privacy protocols, keeps recommendation quality high by strategically using the server's ample storage resources, and reduces server-side overhead by performing some computations using the on-device model.

The proposed approach provides various additional advantages. For example, the on-device model may use privacy protocols to communicate with multiple servers, each server being specialized for a different use case (e.g., travel recommendation, weather, sports, etc.). This allows for the servers to be trained independently of each other, thereby enabling individual development teams to create their own recommendation engines. Additionally, the device may supplement responses from one or more servers with on-device personal information (e.g., device location, user health information) to generate high-quality recommendations on-device.

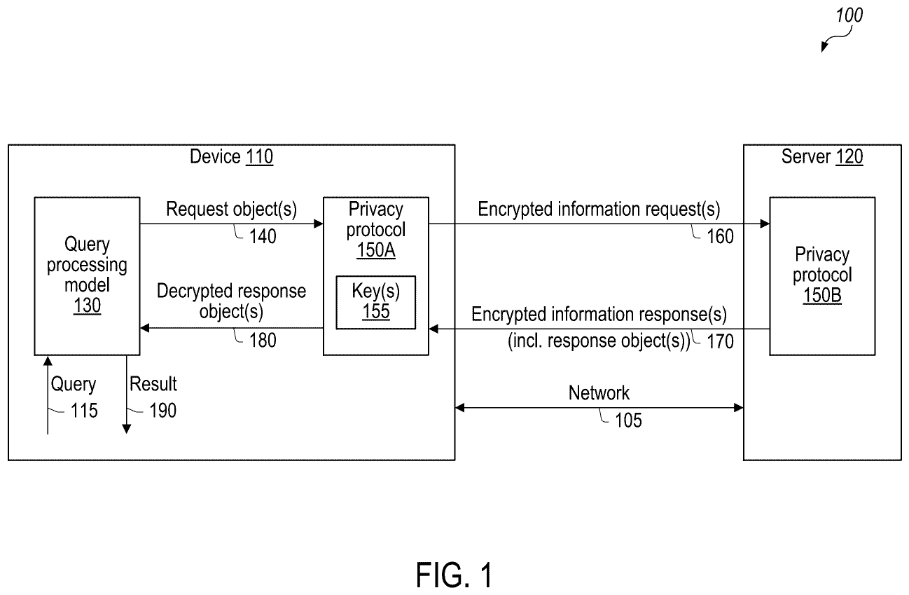

This paradigm is illustrated in FIG. 1, which depicts a block diagram of one embodiment of system 100 for generating and providing results 190 to queries 115. As will be described, device 110 sends an encrypted information request 160 to server 120 and receives an encrypted information response 170, whose included objects are decrypted to provide result 190. As depicted, device 110 and server 120 are coupled over a network 105, which may be any suitable type of connection, including a wide-area network, local area network, short-range network (Bluetooth, etc.) and the like.

Computing device 110 is any device configured to use privacy protocol 150A to send encrypted information requests 160 relating to an input query 115. Device 110 then receives an encrypted information response 170 from server 120 and decrypts it into decrypted response objects 180, which are used to generate result 190. In many cases, device 110 may be a phone, a tablet, a personal computer, an e-book reader, or any type of similar user-facing device. In some cases, device 110 may have specific hardware (e.g., a Secure Enclave Processor (SEP)) that assists in encryption and decryption operations. Device 110 may store query processing model 130, which may be used in various aspects of servicing query 115.

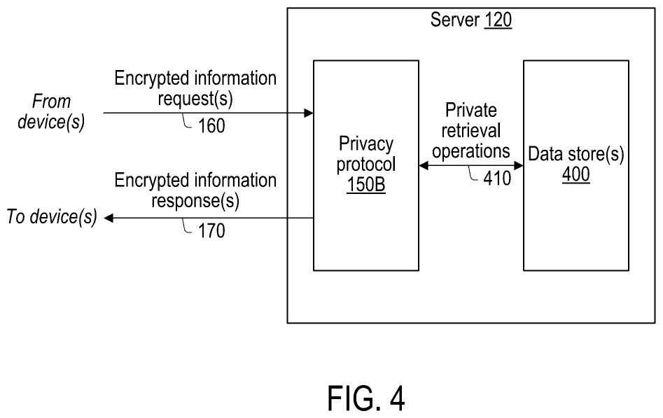

Server 120 is a computing device configured to receive encrypted information request 160 from device 110 and send a subsequent encrypted information response 170 back to device 110. As shown, server 120 also includes response objects in response 170, which server 120 cannot access in plaintext form due to the nature of privacy protocol 150. Server 120 may be any suitable type of computing device and may be comprised of one or multiple distributed computing devices. Server 120 may, for example, be any type of computer system that stores or has access to one or more types of digital content. As such, server 120 may be a media server, an app store, an online shopping website, or any other type of system that may benefit from sending responses to users. One embodiment of server 120 will be discussed in more detail with respect to FIG. 4. Although one server is shown in system 100, other embodiments may include multiple servers acting together.

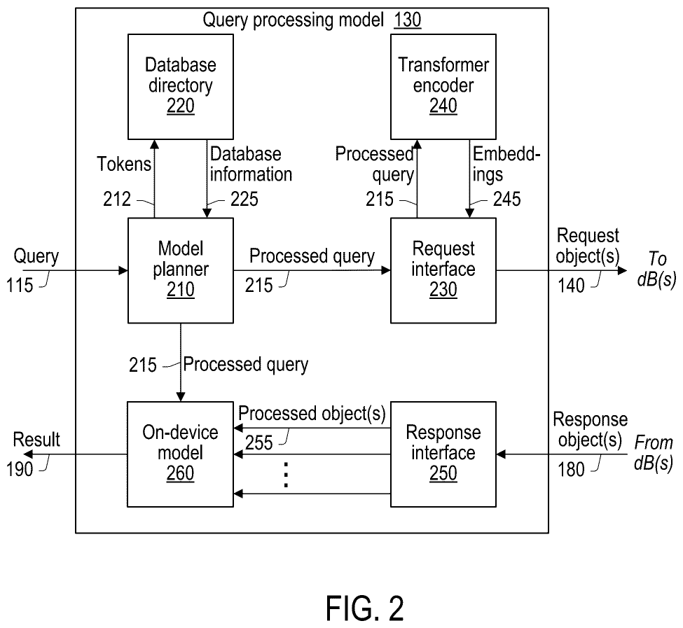

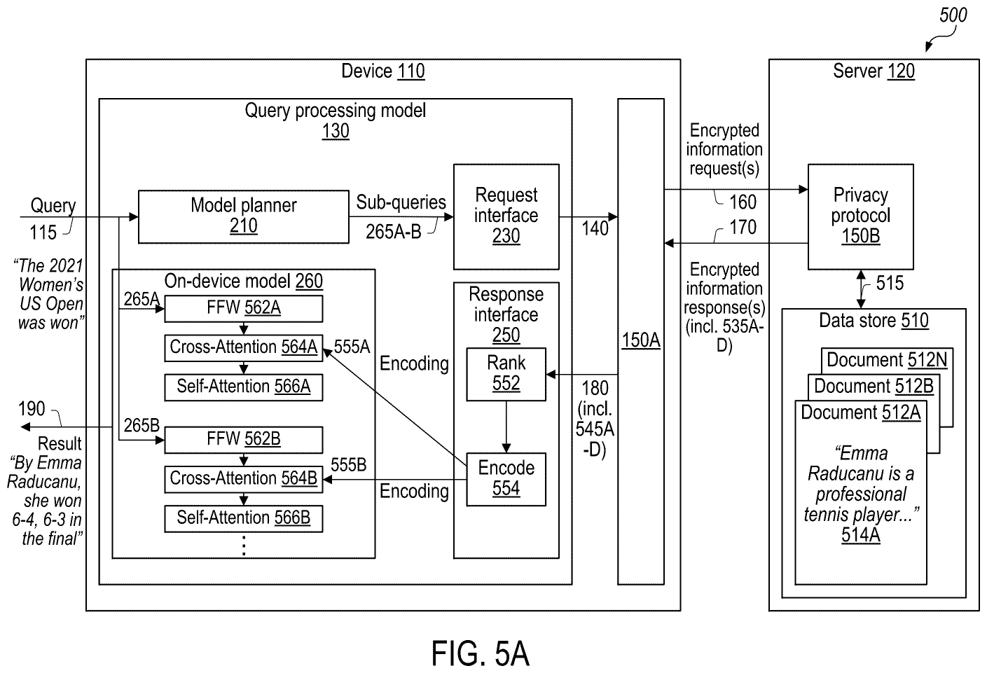

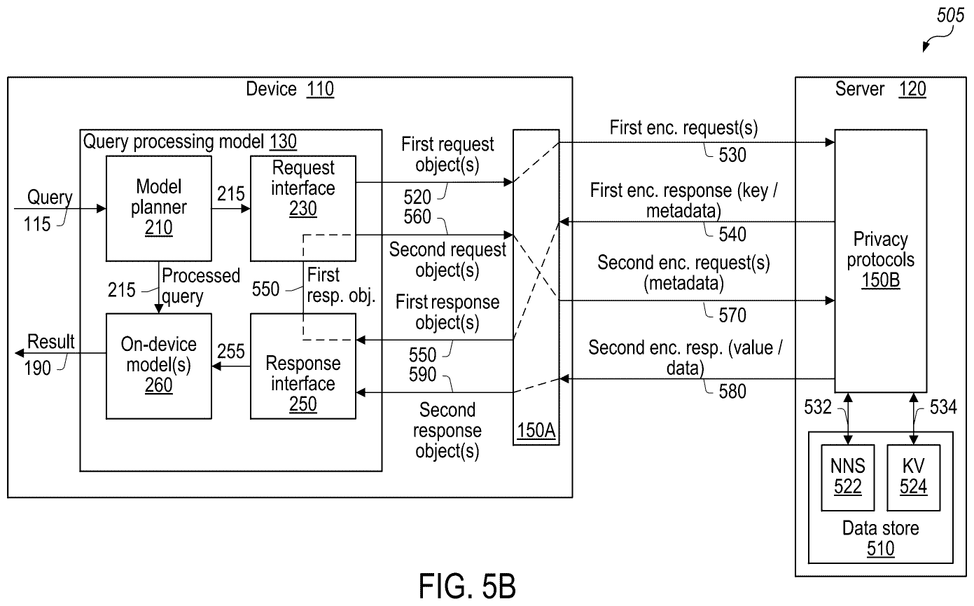

Device 110 stores query processing model 130 executable to perform various operations related to generating result 190 to query 115. As depicted, query processing model 130 receives query 115 and generates request objects 140, which are included in encrypted form as part of requests 160. Furthermore, model 130 receives decrypted responses objects 180, which are used to generate result 190 in response to query 115. In one embodiment, objects 180 are embeddings used in a cross-attention model, as will be described in more detail with respect to FIG. 5A. The use of on-device model 130 advantageously allows for device 110 to perform processing of sensitive information locally, while still benefiting from the relatively large storage capacity of server 120 and without unduly taxing server 120. One embodiment of model 130 is described in more detail with respect to FIG. 2.

As shown, device 110 and server 120 communicate via privacy protocol 150, which is shown as split into privacy protocol 150A and privacy protocol 150B. Operations of protocol 150 that are performed by device 110 are depicted as privacy protocol 150A, which uses keys 155 for cryptographic operations such as encryption/decryption. On the other hand, operations of protocol 150 that are performed by server 120 are depicted as privacy protocol 150B. In various embodiments, protocol 150A and protocol 150B are simply two portions of the same overall paradigm. Notably, the use of protocol 150 allows server 120 to perform various operations without being able to read the plaintext of request objects 140, query 115, etc.

Encrypted information requests 160 are sent by device 110 to server 120 via network 105 using protocol 150. Encryption information request 160 may be encrypted by device 110 using homomorphic key encryption with a (symmetric or asymmetric) key 155 of device 110. In some embodiments, device 110 may send multiple encrypted requests 160 in multiple rounds of each privacy protocol 150A depending on, for example, the personalization level of the response that system 100 desires to provide. Accordingly, single-stage and multi-stage operations are discussed herein. Note that, although not pictured in FIG. 1, additional unencrypted data may accompany encrypted information request 160. For example, an unencrypted request type flag might be sent to server 120 that describes the specific type of operation being performed. Encrypted information request 160 may, in some embodiments, be sent to server 120 as an Application Programming Interface (API) function call.

As depicted, encrypted information responses 170 are sent by server 120 to device 110 over network 105 in response to encrypted information requests 160. In this manner, encrypted information responses 170 cannot be decrypted or otherwise read in plaintext form by server 120. If information requests 160 are homomorphically encrypted, then encrypted information response 170 is in ciphertext that can be decrypted only using information requests 160's decryption key. Furthermore, responses 170 may be of various formats depending on the type of requests 160. For example, encrypted information response 170 may contain one item for model 130 to use in generating result 190. Alternatively, information response 170 may contain a list of multiple response objects for use in processing model 130. Multiple information responses 170 may also be output by server 120 depending on the number of encrypted information requests 160. For example, server 120 may return, in ciphertext form, multiple response objects 180 that most closely match request objects 140.

Result 190 is provided to the user by model 130 based on decrypted response objects 180. As will be described in more detail with respect to FIG. 2, model 130 may input response objects 180 into an on-device model to generate result 190. Result 190 may be in any suitable format. For example, result 190 may be a response in plain English sent to the user based on a request sent by the user using a virtual assistant. Result 190 may be provided to the user in response to user input. For example, if query 115 is “Who won the United States Women's Open for tennis in 2014?,” result 190 might include the text “Serena Williams.” But result 190 might also be provided automatically without a user prompt. For example, query 115 might be generated by a background process performed by an operating system of device 110.

Device 110 is thus able, using privacy protocols 150 and query processing model 130, to receive precise results 190 to query 115. This may be accomplished without unnecessarily divulging sensitive information to server 120 or without server 120 performing more computation than is necessary. Furthermore, result 190 may be of higher quality than if generated only using information available at the device.

FIG. 2 is a block diagram of one embodiment of query processing model 130 stored in device 110. As shown, query processing model 130 includes a model planner 210, database directory 220, request interface 230, transformer encoder 240, response interface 250, and on-device model 260. Processing model 130 receives query 115, which it uses to send request objects 140 to one or more databases (which may be implemented at server 120 or on device 110), and generates result 190 based on response objects 180 received from one or more databases. The term “database” is used herein broadly to refer to an information repository. The term “data store” is also used in this disclosure to refers to information repositories.

Model planner 210 is executable to generate a processed query 215 by at least using query 115 and database information 225. As will be discussed in more detail, model planner 210 first tokenizes query 115 into tokens 212, forwards those tokens to database directory 220 and retrieves database information 225. Then, model planner 210 uses database information 225—which may include tokens 212 and additional metadata—to analyze query 115 and route resulting processed query 215 to the appropriate destination database(s) and model(s).

First, model planner 210 generates tokens 212 from query 115. As is understood in the art, tokens represent the units of text input, such as keywords, operators, and identifiers, extracted from query 115. These tokens serve as the foundation for syntactic analysis, enabling the understanding of the structure, semantics, tone, topic, etc. of query 115. The granularity of tokens 212 may vary based on the implementation of components of model 130 (e.g., model planner 210, database directory 220, on-device model 260) Thus, tokens 212 may be individual words of model query 115, grammatical clauses of query 115, etc.

Then, model planner 210 sends tokens 212 to database directory 220 to retrieve database information 225. Database directory 220 includes data that describes what databases, be it on-device or server-side, are available to service query 115 (or sub-queries thereof). Thus, database directory 220 may be used to determine which database(s) to route query 115 to based on the query's tokens 212. Database information 225 may, for example, be an extracted topic of query 115 (e.g., sports, travel). As another example, database information 225 is an identifier of a particular database. In one embodiment, database directory 220 is implemented as a knowledge graph generated by model planner 210. In another embodiment, database directory is implemented a classifier.

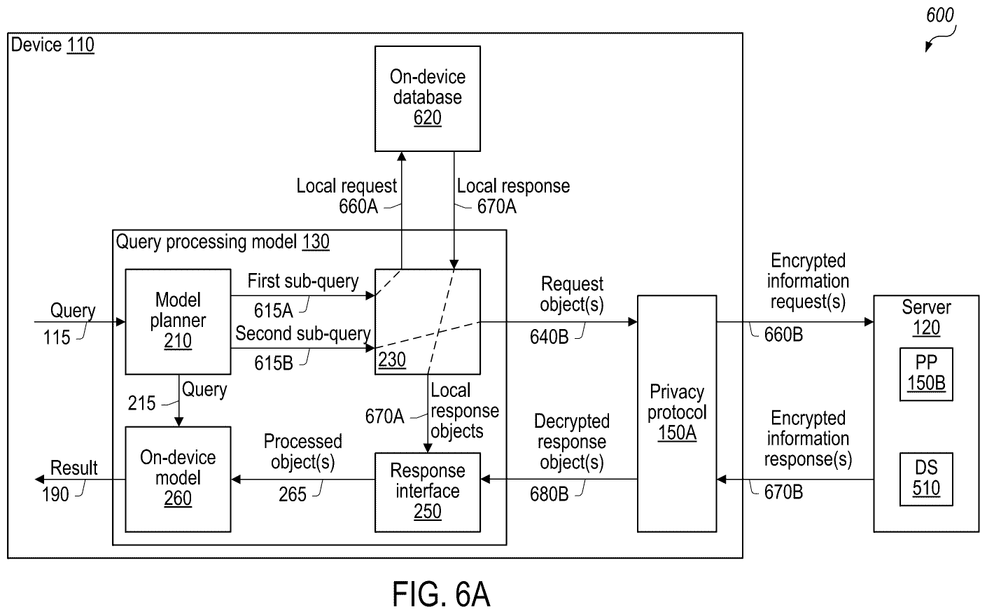

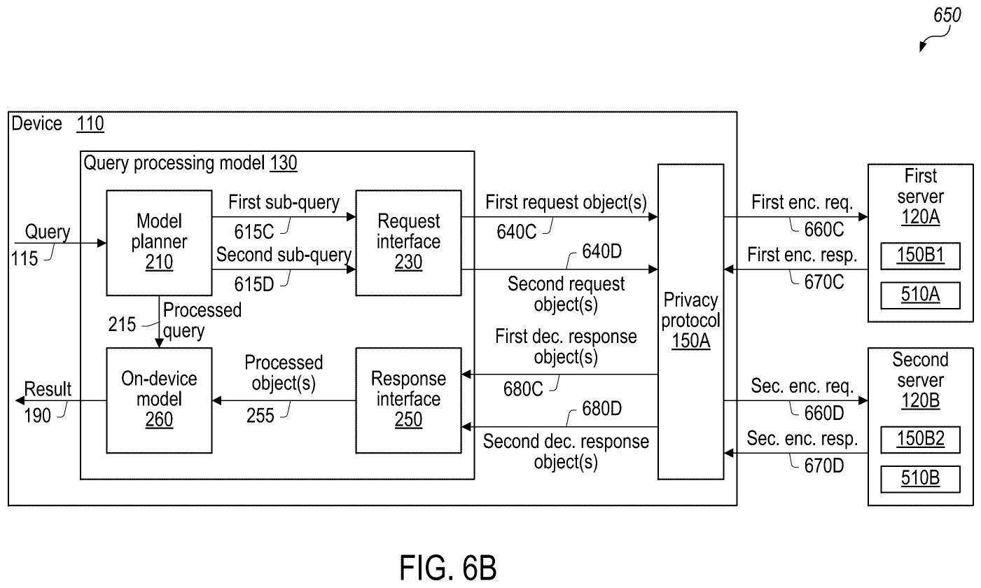

Once planner 210 has received database information 225, it analyzes query 115. When analyzing query 115, model planner 210 may make various decisions based on the contents of query 115. Example decisions include determining whether query 115 is to be serviced locally by device 110 or remotely by server 120, whether to split the query into multiple sub-queries, whether to send the request to a single database or multiple databases (which may be on-device as shown in FIG. 6A or server-based as shown in FIG. 6B), which of multiple on-device models 260 to select, etc. Model planner 210 may thus use database information 225 in a variety of ways to determine various aspects of how query 115 is to be serviced.

In some embodiments, model planner 210 may, as part of its analysis, also determine the format in which request objects 140 are to be sent, such as embeddings. Embeddings, as is understood in the art, are vector representations of text that encode various features of the text as values within the vector. For example, one embedding might be used to capture the tone of a particular query 115. Due to their ability to capture various features of query 115, embeddings can be used as inputs to various retrieval operations that return embeddings with similar features. As an additional example, database information 225 may also be used to select on-device model 260 out of multiple available on-device models, which may have further ramifications on the data types of both request and response objects.

After analyzing query 115, model planner 210 generates, based at least on information 225, processed query 215 to be sent to both request interface 230 and on device model 260. Processed query 215 is a version of query 115 that includes metadata that is useful to service query 115 or that is generated as a result of the analysis of model planner 210. For example, processed query 215 may include database information 225, tokens 212, an identifier of the on-device model 260 that was selected, whether the request is a request a local database or a server-side database, etc. Alternatively or additionally, processed query 215 may also include a non-tokenized copy of query 115 (e.g., a raw string).

Request interface 230 is responsible for generating and sending request objects that are compatible with one or more databases to be accessed. In the depicted embodiment, interface 230 sends processed query 215 to transformer encoder 240, which converts processed query 215 into embeddings 245. Transformer encoder 240 may implement an embedding algorithm that uses item-related inputs, such as text, item metadata, or user preference data. For example, embeddings 245 may be generated using a text embedding function (e.g., Word2vec, fastText, BERT) that extracts various features of the text, such as tone, topics, type of requested item using query 115. In one embodiment, encoder 240 is trained to extract the similarity of words of query 115 to various other words, and store that similarity as data in embeddings 245. Alternatively, encoder 240 may download embeddings 245 from a third-party server that hosts pre-computed embeddings. This embedding download operation may itself be performed using a privacy protocol with the third party to preserve the privacy of query 115. Request interface 230 may include embeddings 245 within request objects 140 (e.g., in encrypted form) to be used in various operations at server 120. For example, embeddings 245 can be used by server 120 to retrieve various objects similar to embeddings 245.

Note that request interface 230 may send request objects 140 to multiple destination databases. One example of such a database is described in more detail with respect to a data store shown in FIG. 4. Another possible destination database is a local on-device database, whose interaction with interface 230 is described in more detail with respect to FIG. 6A.

But in other cases, information in processed query 215 may indicate that embeddings are not necessary. For example, model planner may determine a particular key using query 115 that is used in plaintext in a key-value request that returns the data needed by on-device model 260. In other embodiments, interface 230 may perform different encoding and/or conversion operations due to database information 225 in processed query 215 specifying other information types. These information types include, without limitation, Bag-of-Words representations, graph-based representations, rule-based systems, symbolic Artificial Intelligence (AI), any combination thereof, and the like.

Eventually, query processing model 130 receives response objects 180, which are generated by decrypting response 170 (not shown). Response interface 250 processes these response objects 180 and generates processed objects 255 to send to on-device model 260. For example, response object 180 may be an entire article about a topic generally relevant to query 115, and processed objects 255 are embeddings generated based on the article using a transformer encoder. Then, on-device model 260 uses processed query 215 and processed objects 255 to generate result 190. An example implementation of model 260 is described in more detail with respect to FIG. 5A. Request objects 140 and/or response objects 180 may be embeddings, a raw query, an image file, an audio file, etc. Response interface 250 may determine the format of response object 180 based on information generated by analysis of model planner 210, such as metadata of processed query 215.

To recap, query processing model 130 receives a query 115 and forwards it to model planner 210, which selects via database directory 220 information used to determine the format of request objects 140, the particular on-device model 260, the destination database(s), etc. A version of query 115 (processed query 215) is forwarded to request interface 230, which can use encoder 240 to generate encodings used as part of request objects 140, which are routed to the appropriate destination(s). Subsequently, response interface 250 receives response objects 180, which it processes into processed objects 255, which are used alongside processed query 215 by on-device model 260 to generate result 190.

In some embodiments, model planner 210 may, based on database information 225, split query 115 into multiple sub-queries. For example, the query “when is the Super Bowl LVIII kickoff time, Central Time” may be split into two sub-queries, one corresponding to “when is the Super Bowl L VII kickoff time,” and another corresponding to “Central Time.” Various techniques to split query 115 are contemplated. In one implementation, model planner 210 tokenizes query 115 and references it against on-device string-token based hash-maps/bloom filters. In another implementation, model planner 210 forwards query 115 to a privacy-preserving server that performs the splitting off-device and returns sub-queries. In yet another implementation, model planner 210 encodes query 115 into an embedding, performs a similarity check on the embedding against an embedding-based code book, retrieves sub-string embeddings based on the similarity check, and queries a privacy-preserving server to receive in return the highest-scoring sub-string embeddings.

In some cases, sub-queries may be used to send requests to different servers based on each sub-query's use case. Thus, in one embodiment described in more detail with respect to FIG. 6A, model planner 210 might cause device 110 to use, for a single query 115, one sub-query for a request to server 120, and another sub-query for a request to a database internal to device 110. In another case described in more detail with respect to FIG. 6B, model planner 210 might determine to use, for a single query 115, one sub-query 265 to one external server, and another sub-query 265 to a different external server.

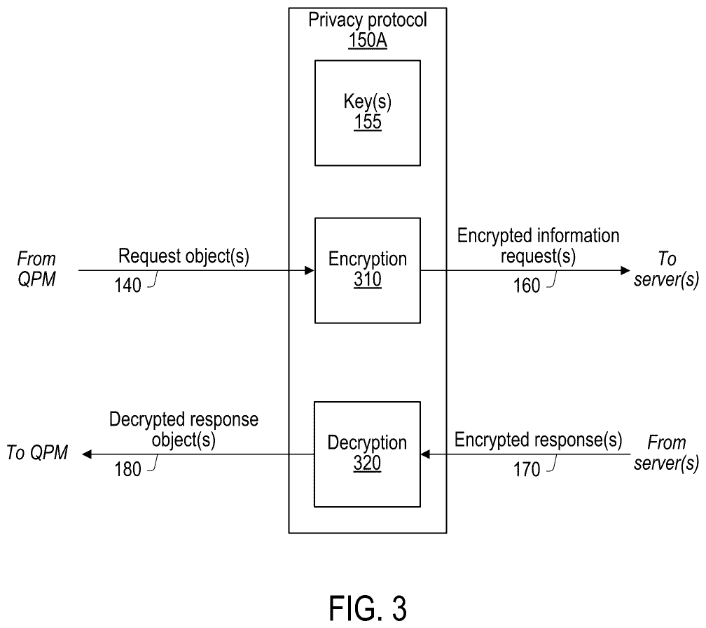

FIG. 3 is a block diagram of one embodiment of a device-side privacy protocol 150A as implemented in device 110. As shown, privacy protocol 150A is executable to perform encryption 310 and decryption 320 using keys 155. Operations other than encryption 310 and decryption 320 may also be performed as part of privacy protocol 150A. For example, privacy protocol 150A may include multiple stages of communication that rely on multiple servers, multiple sub-components of server 120, etc.

After query 115 is processed by query processing model 130, a module implementing protocol 150A receives request objects 140 and performs encryption 310 to generate encrypted information request(s) 160. Once device 110 receives response(s) 170 that correspond to request(s) 160, protocol 150A is usable to perform decryption 320 of encrypted response 170 to generate decrypted response objects 180. In some embodiments, encryption 310 and decryption 320 are performed using different keys. Note that privacy protocol 150A may perform multiple encryptions 310 on multiple sub-queries 265 included as part of request objects 140. Example privacy protocols are described in more detail with respect to FIGS. 5A-B.

In one embodiment, operations of privacy protocol 150A are facilitated by secure hardware on device 110. One example of such secure hardware is an SEP circuit that is configured to facilitate encryption 310 and decryption 320.

FIG. 4 is a block diagram of one embodiment of a server computer system 120 that is configured to communicate with device 110 according to protocol 150. As shown, server 120 includes modules implementing privacy protocol 150B and a data store 400. Data store 400 is an information repository that stores data that may be utilized to help respond to query 115. In some cases, data store 400 might be a specialized information store (e.g., limited to health recommendations). In some cases, server 120 may include multiple different types of data stores. Also as shown, privacy protocol 150B, in response to encrypted request(s) 160, uses private retrieval operations 410 to communicate with data store 400 and return encrypted recommendation response(s) 170. As has been explained, private retrieval operations 410 prevent server 120 from having access to requests 160 and responses 170 in plaintext form.

Server 120 is configured to interface (e.g., via an API) with requesting computing devices (e.g., device 110) using privacy protocol 150B. When server 120 receives encrypted requests 160, it performs private retrieval operations 410 to retrieve the appropriate data, and accordingly return encrypted information response 170. The use of private retrieval operations 410 ensures that server 120 does not have access to the plaintext versions of request(s) 160, data processed in operations 410, or response(s) 170. In one embodiment, private retrieval operations 410 are homomorphic operations, with request(s) 160 being homomorphically encrypted.

Server 120 may be configured to perform various types of private retrieval operations 410. Thus, in one embodiment, server 120 may select between various operation types based on its configuration and type of data being requested. For example, the selection may be performed based on additional plaintext information (e.g., a request type value) accompanying request 160. Thus, in one embodiment, server 120 may, based on the type of protocol that is selected, select a nearest neighbor search (NNS) operation, a key-value (KV) operation, or a combination thereof. Techniques for performing various types of private retrieval operations 410, including NNS and KV operations, are described in more detail in U.S. patent application Ser. No. 18/437,866, filed Feb. 9, 2024, and titled “Privacy-Preserving Recommendation Generation,” which is incorporated by reference herein in its entirety.

Since server 120 has its own data store 400, server 120 can be trained independently of the on-device model 260 and independently of other individual servers. Such a paradigm results in higher quality compared to 1) a paradigm in which one device stores the entire model data, and 2) a paradigm employing one multi-purpose server that has data for multiple-use cases. Server 120 thus has a higher capacity than device 110, and can also have its data continuously updated without necessarily having to update on-device model 260. Furthermore, a server that is trained to specialize in one use case can provide higher-quality results than a server trained in multiple-use cases, as training with widely disparate data may render the model less precise with respect to individual topics. (An additional advantage is that a specialized server will have to store less data and have less training than a single generaluse server.) Thus, in one embodiment, a model split between device 110 and server 120 can benefit from both the performance and privacy of on-device model 260, and the capacity, quality, and recency of information in data store 400.

FIG. 5A is a block diagram of one embodiment of a query processing system 500 having a query processing model 130 implemented as a Retrieval-Enhanced Transformer (RETRO) model (e.g., RETRO, RETRO++, InstructRetro, etc.). (Other model types, such as graph neural networks (GNNs), probabilistic graphical models (PGMs), ensemble models, sparce models, etc. may be employed in other implementations.) To facilitate explanation of system 500, processing of a particular query (“The 2021 Women's U.S. Open was won”) is shown.

A particular focus of FIG. 5A is on-device model 260. Features of model 260 are thus discussed briefly before turning to processing of query 115. On-device model 260 receives sub-queries 265A-B and performs operations to complete the sentence specified by the sub-queries. As with a number of language models, on-device model 260 performs various operations implemented as layers, where each layer is shown as a separate box (e.g., Feed Forward (FFW) 562, Cross-Attention 564, Self-Attention 566). Model 260 uses, for each sub-query/result pair, a respective RETRO block consisting of FFW layer 562, cross-attention layer 564, and self-attention layer 566. Once the operations for all RETRO blocks are completed, model 260 outputs a final result 190.

Another focus of FIG. 5A is its use of documents 512 in server 120. Data store 510 stores documents 512, which are full documents that have more information than is typically needed to service query 115. Once device 110 downloads and processes documents 512 via protocol 150, it generates embeddings that capture the relevant parts of documents 512 used to generate result 190. For example, if a particular query requested a given artist's albums and the retrieved document 512 is an encyclopedia article for the artist, then the embeddings might only be based upon the “Albums” section of the encyclopedia article.

First, model planner 210 selects the particular model (in this case, RETRO model 260) and destination server 120 for query 115. Then, according to the selection, model planner 210 proceeds to split query 115 into two sub-queries 265A-B. (Note that query 115 may be split into more than two sub-queries if it is worded differently, is used in other on device models, etc.). In addition, model planner 210 routes sub-queries 265A-B to on-device model 260 once device 110 receives a response 170.

Model planner 210 forwards sub-queries 265A-B to request interface 230. Request interface 230 in turn encrypts sub-queries 265 to formulate encrypted information requests 160, and proceeds to send requests 160 to server 120. In one example, request interface 230 encodes sub-queries 265A-B into embeddings prior to encrypting them and including them in requests 160.

As shown, server 120 performs retrieval operations 515 based on request 160 to return four encrypted documents 535A-D as part of response 170. Server 120 uses privacy protocol 150B to perform, for each encrypted version of sub-query 265A-B, an NNS retrieval operation 515 in data store 510 and accordingly returns encrypted documents 535A-B corresponding to sub-query 265A and encrypted documents 535C-D corresponding to sub-query 265B. In some embodiments, protocol 150B may select encrypted documents 535A-D based on their cosine similarity to sub-queries 265A-B. (Note that due to privacy protocol 150, server 120 cannot read plaintext versions of encrypted documents 535 but can nonetheless service sub-queries 265.) Then, server 120 returns encrypted documents 535A-D in response 170 to device 110 via protocol 150, such that device 110 respectively decrypts documents into plaintext documents 545A-D.

Note that there are multiple ways to perform retrieval operation 515. In one embodiment, retrieval operation 515 is performed using a single round using one homomorphic NNS operation that directly retrieves document 512. But in other embodiments, retrieval operation 515 is performed in two rounds, as described in more detail with respect to FIG. 5B. The use of two rounds may advantageously save computation and time relative to a single-round retrieval. In general, any suitable type of retrieval operation is contemplated.

Response interface 250 then processes the plaintext documents 545A-D to forward them to model 260. More particularly, once response 170 is decrypted into plaintext documents 545, response interface 250 ranks documents 545A-D at ranking 552. In one embodiment, the top-ranked document for each sub-query 265A-B is respectively encoded at 554 as encoding 555A-B, and is forwarded to respective RETRO blocks of model 260. (In another embodiment, the order of operations is reversed such that documents 512 are first encoded at 554, and then their encodings are ranked at 552.)

On-device model 260 then processes the data to generate result 190. Model 260 feeds each sub-query 265A-B into its respective FFW layer 562A-B, forwards that output alongside respective encoding 555A-B to cross-attention layer 564A-B, whose output is finally forwarded to respective self-attention layer 566A-B. Finally, all outputs are incorporated into result 190, which is a completion of the sentence uttered at query 115, with information integrated from encodings 555.

Consider, for example, the use of a query that asks, “The 2021 Women's U.S. Open was won.” The system, using model 260, completes the sentence of the query by returning “by Emma Raducanu, she won 6-4, 6-3 in the final” as a result. In this example, the data needed to complete the sentence includes document 512A, which is a biography of Emma Raducanu whose relevant features were extracted by on-device model 260 to better answer query 115. These relevant features may be, for example, a sentence in the article that states that Emma Raducanu has won the 2021 Women's U.S. Open.

FIG. 5B is a block diagram of one embodiment of a query processing system 505 in which two rounds of communication between device 110 and server 120 are performed according to a privacy protocol 150A. As shown, server 120 is configured to perform a first round consisting of a NNS metadata retrieval, and a second round consisting of a KV data retrieval. Also as shown, these retrievals are respectively performed using NNS store 522 and KV store 524 in data store 510.

The exchange begins with model planner 210 receiving/processing query 115 and determining that the query is to be serviced in two rounds and using model 260. Various components of model 130 may assist in the determination to perform two rounds. For example, model planner 210 may retrieve, using database directory 220 (not shown), database information in response to query 115 that specifies a particular server 120 whose implementation requires two rounds of communication.

As depicted, model planner 210 routes processed query 215 to request interface 230. Then, request interface 230 generates request objects 520 and 560 for each round based on the contents of query 215 and the current round. In some embodiments, request interface 230 maintains a finite state machine to track which of the two rounds of retrieval is currently being performed.

In the first round, privacy protocol 150A causes the sending of first encrypted request 530 to server 120 to retrieve an identifier (also referred to as metadata) as part of first response 540. Server 120 receives request 530, and retrieves the identifier(s) using an NNS operation 532 on NNS store 522. Server 120 then returns the identifier in encrypted form as an output of NNS operation 532 in first response 540. The identifier(s) of first response 540 may be, for example, for one or more items (e.g., article, image, code, etc.) responding to a question asked in query 115, completing a sentence of query 115, that is similar to a sub-query of query 115, etc.

Once device 110 receives first response 540, request interface 230 initiates the second round, which is based on the decrypted first response objects 550 from the first round. First, protocol 150A decrypts first response 540 into first response objects 550, and then forwards first response objects 550 Then, as shown by the dashed lines, response interface 250 sends the first response object to request interface 230, which it then uses to initiate the second round. Request interface 230 may, for example, update its finite state machine to reflect the second round.

Then, request interface 230 uses first response objects 550 to send second request objects 560 to protocol 150A. First response objects 540 and second request objects 560 may be identical in some cases and thus include the same identifiers. But in other embodiments, request interface 230 may process and/or modify first response objects 540 to generate second request objects 560. For example, response objects 540 may include multiple pieces of metadata identifying various paragraphs within a particular article, and interface 230 may select one or more (but not all) article identifiers as part of second request objects 560. This selection may be in some cases performed using metadata received from processed query 215 and maintained by request interface 230.

Once privacy protocol 150A receives second request objects 560, it generates and sends second request 570. For example, consider the scenario in which the first request was for a document identifier. In that scenario, second request 570 is the actual article or document whose identifier is included in first response objects 550.

Server 120 receives second encrypted request 570 and performs KV retrieval 534 for the piece of data (i.e., the value) corresponding to the metadata (i.e., the key) from KV database 524. The retrieved data is then returned as second encrypted response 580. As with other database operations in server 120—including NNS operation 522—KV retrieval 534 is performed without server 120 knowing the plaintext contents of request 570 or response 580.

The device receives second encrypted response 580, decrypts it into second response objects 590, and uses resulting processed objects 255 alongside processed query 215 to generate result 190. In one embodiment, on-device model 260 extracts relevant information from 590 response objects, and uses the extracted information to generate result 190. Thus, the two-round process was able to best answer query 115 in a privacy-preserving way using the computing power of on-device model 260 and the capacity of data store 510 in server 120.

Note that the system of FIG. 5B may implement the example depicted in FIG. 5A. In an example two-round implementation of system 500, NNS store 522 stores document IDs in an embedding space, KV store 524 stores the documents themselves as values indexed by document IDs, and on-device model 260 is a RETRO model. In another implementation, the system of FIG. 5B may receive a query to generate an image, and use a generative image model based on a generative adversarial network (GAN) architecture as on-device model 260 that retrieves multiple images as specified by a query. The first request requests image IDs in an embedded embeddings that correspond to embeddings generated using the query, and the second request requests the actual images corresponding to the returned IDs. Then, on-device model 260 processes the downloaded images as specified by the query.

FIG. 6A is a block diagram of one embodiment of a system 600 for servicing a query using data from both a local on-device database 620 and a data store 510 of server 120. As shown, each request destination receives a separate request 660, but the respective results are combined by model 260 to generate result 190. The use of on-device database 620 may also provide privacy, as some information would not even need to leave device 110 if (partly or wholly) serviced by on-device database 620.

Processing begins with model planner 210 determining, based on query 115, that both on-device database 620 and server 120 are to be used in servicing query 115. In one embodiment, this determination is made based on model planner 210 receiving database information that specifies that both database 620 and server 120 should be used to process query 115. For example, model planner 210 may identify that some of the requested data is pertinent to an application of device 110, and thus determine that an internal database 620 can be used to retrieve data from that application.

In response to this determination, planner 210 splits query 115 into sub-queries 615A-B and forwards them to request interface 230. Subsequently, request interface 230 uses first sub-query 615A to query on-device database 620 and the second sub-query 615B to query server 120. For example, query 115 might be “plan a holiday that does not overlap with my work calendar,” where the first sub-query is for on-device work calendar data, and the second query is for travel information from a server 120 that is configured to store various travel information (e.g., resort locations, flight dates and prices, etc.).

On-device database 620 is a data store local to device 110. For example, database 620 may be a cache of an application executing on device 110, a file that is stored in a filesystem of an operating system executing on device 110, or even a data structure stored in random access memory and accessed by API functions called by request interface 230. Furthermore, database 620 may have various implementations, such as a KV database, a database whose data is indexed by keys in an embedding space, a relational database, a JSON file, etc.

Database 620 may, due to the potential sensitivity of its stored data, be further secured in device 110 in various ways to prevent unauthorized parties from accessing it. For example, database 620 may be an encrypted file decryptable only by model 130. This encryption (and corresponding decryption) may be implemented by secure software executing on device 110, secure hardware (e.g., an SEP) of device 110, or a combination of both. As another example, an operating system executing on device 110 may assign various access permissions database 620 and forbid unauthorized accesses.

Furthermore, database 620 may store data for specific types of data that are especially sensitive, even relative to data sent to privacy-preserving servers such as server 120. As an example, on-device database 620 is implemented to store calendar files (e.g., ICALENDAR.ICS files) and is continuously synchronized with a calendar application executing on device 110. As another example, on-device database 620 is implemented to store health information (e.g., previous exercises, resting heart rate, BMI, height, weight, etc.). But regardless of use case, on-device database 620 can be accessed by request interface 230 using local requests, as will be described below.

Once request interface 230 sends local request 660A to on-device database 620, it receives local response objects 670A, which are forwarded to response interface 250. For example, if sub-query 615A is for on-device work calendar data, then response object 670A may be an ICAL file, a comma-separated value (CSV) file, a JSON file, etc. that includes periods in which the user has no other events in their on-device calendar application. In one embodiment, local response object 670A is encrypted, but in another embodiment object 670A is in plaintext, but communicated to model 130 in a secure manner. For example, response object 670A may be stored in an area of memory that only model 130 is permitted to access).

In conjunction with local request 660A, request interface 230 also sends a request 660B to server 120. Various methods of communicating with server 120 using privacy protocol 150 have already been described elsewhere. First, interface 230 forwards request object 640B based on second sub-query 615B. Then, request object 640B is encrypted into encrypted information request 660B, which is serviced by server 120 that returns encrypted information response 670B. Privacy protocol 150A decrypts encrypted information 670B into decrypted response objects 680B, and forwards it to response interface 250. Once response interface 250 receives both response objects 670A and 680B, it processes them and forwards them as processed objects 255.

Then, on-device model 260 uses processed objects 255 from both request on-device database 620 and server 120 to generate result 190. Consider the previously described query that asks the device to plan a holiday around the user's calendar. In that example, local response objects 670A include the on-device calendar information, and decrypted response objects 680B are lists of various locations and opening hours for those locations. Accordingly, model 260 generates result 190, which is a full list of potential flights and locations with times that are in accord with both opening hours and on-device calendar information. In another scenario, another query asks for a specialized exercise plan based on the user's health metric. In that example, local response objects 670A include various health metrics (e.g., height, weight, age, heart rate, general fitness, etc.), and decrypted response objects 680B are exercises at various fitness levels for a general population. Accordingly, model 260 generates a result that is a list of workout routines based on the user's various health metrics.

In some cases, data from on-device database 620 (and other on-device sources) may be used to modify request objects 640B before they are used by on-device model 260. For example, data in on-device database 620 may be used to fine-tune embeddings generated by transformer encoder 240, encode operation 554 (neither of which is shown), or other sub-components of model 130. Thus, this modification will apply to request objects 640B (if they were implemented as embeddings), and will be reflected in response objects 680B and ultimately result 190 to make it more reflective of user preferences.

FIG. 6B is a block diagram of one embodiment of a system 650 for servicing a query using data from different servers. As shown, query 115 is serviced using data from servers 120A and 120B. These servers have respective data stores 510A and 510B and protocols 150B1 and 150B2.

When query processing model 130 receives query 115, model planner 210 determines that data is to be retrieved from two separate servers 120A and 120B. In one embodiment, model planner 210 analyzes tokens of query 115 and retrieves database information (e.g., using a database directory) specifying servers 120A-B. Additionally, model planner may select an on-device model 260 (e.g., a RETRO model) that is executable to synthesize information from multiple sources to provide a higher-quality output than doing so using a single source.

After the determining, model planner 210 splits query 115 into a first sub-query 615C that is used to query server 120A, and a second sub-query 615D that is used to query server 120B. For example, query 115 might be “what would take longer, reading Of Mice and Men or watching the movie?” In that case, planner 210 splits query 115 into a first sub-query for a book database configured to store bibliographic information such as reading times, and a second sub-query for a movie database configured to store movie metadata such as movie runtimes.

Code implementing privacy protocol 150A then sends requests to both servers 120A-B. First, request interface 230 forwards first request object 640C based on first sub-query 615C. Then, first request object 640C is encrypted into first encrypted information request 660C, which is serviced by first server 120A that returns first encrypted information response 670C. Concurrently with request object 640C, request interface 230 also forwards second request object 640D based on second sub-query 615D. Then, second request object 640D is encrypted into second encrypted information request 660D, which is serviced by second server 120B that returns second encrypted information response 670D.

Code implementing privacy protocol 150A then decrypts encrypted responses 670C and 670D respectively into decrypted response objects 680C and 680D. After decryption, protocol 150A forwards objects 680C-D to response interface 250 as processed objects 255. In one embodiment, response interface 250 extracts relevant features of objects 680C-D to generate processed objects 255.

Then, on-device model 260 uses processed objects 255 (which include objects 680B-C from both servers 120A-B) to generate result 190. Consider the query that asks, “what would take longer, reading Of Mice and Men or watching the movie?” In that example, model 260 compares processed objects 255, corresponding to the book's reading time and the movie's runtime that are extracted by response interface 250. Then model 260, as a result of the comparison, may output a response such as “while the book is very short, watching the movie may still take less time.”

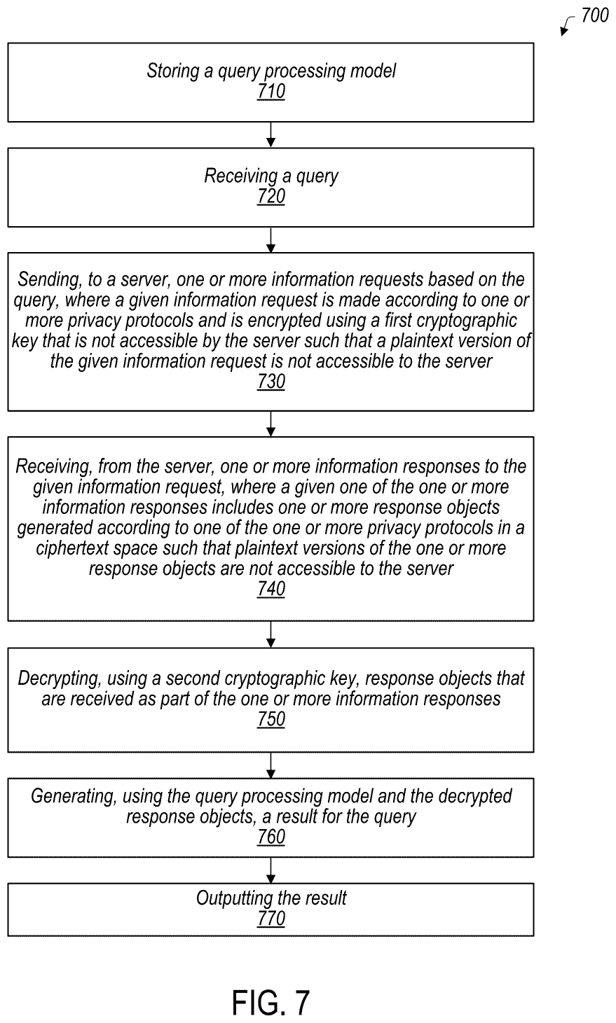

Turning now to FIG. 7, a flow diagram of a method 700 for servicing a query using an on-device model. Method 700 may be performed for example by a device 110. Method 700 may be performed by executing a set of program instructions stored on a non-transitory computer-readable medium. Method 700 is susceptible to numerous variations, some of which are noted below.

Method 700 begins in 710 with the computing device storing a query processing model (e.g., query processing model 710).

In 720, the computing device receives a query (e.g., query 115).

In 730, the computing device sends sending to a server (e.g., server 120) one or more information requests (e.g., encrypted information requests 160) based on the query, wherein a given information request is made according to one or more privacy protocols (e.g., privacy protocol 150) and is encrypted using a first cryptographic key (e.g., a first key of keys 155) that is not accessible by the server such that a plaintext version of the given information request is not accessible to the server.

In 740, the computing device receives from the server one or more information responses (e.g., encrypted information response 170) to the given information request, wherein a given one of the one or more information responses includes one or more response objects (e.g., response objects 180) generated according to one of the one or more privacy protocols in a ciphertext space such that plaintext versions of the one or more response objects are not accessible to the server

In 750, the computing device decrypts, by the computing device using a second cryptographic key (e.g., a second key of keys 155), response objects that are received as part of the one or more information responses.

In 760, the computing device generates, using the query processing model and the decrypted response objects, a result (e.g., result 190) for the query.

In 780, the computing device outputs the result.

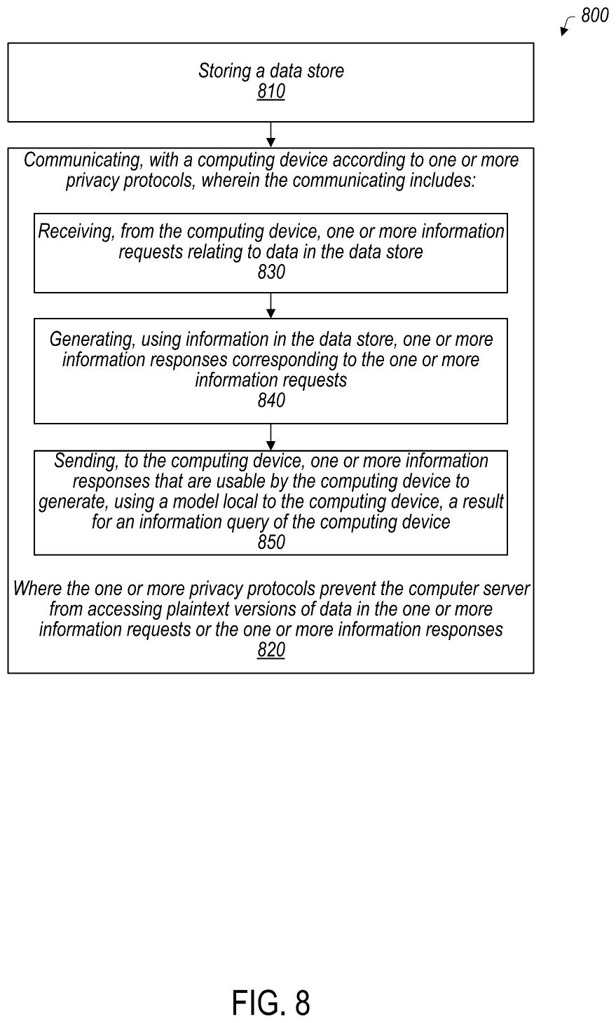

Turning now to FIG. 8, a flow diagram of a method 800 for a server servicing a query from a device that has an on-device model. Method 800 may be performed for example by a server 120. Method 800 may be performed by executing a set of program instructions stored on a non-transitory computer-readable medium. Method 800 is susceptible to numerous variations, some of which are noted below.

Method 800 begins in 810, with the computer server storing a data store (e.g., data store 400).

In 820, the computer server communicates with a computing device (e.g., device 110) according to one or more privacy protocols (e.g., privacy protocol), wherein the one or more privacy protocols prevent the computer server from accessing plaintext versions of data used in the protocol.

In 830, the computer server receives one or more information requests (e.g., encrypted information requests 160) relating to data in the data store.

In 840, the computer server generates one or more information responses (e.g., encrypted information responses 170) corresponding to the one or more information requests.

In 850, the computer server sends the one or more information responses that are usable by the computing device to generate, using a model local to the computing device (e.g., on-device model 130), a result (e.g., result 190) for an information query (e.g., query 115) of the computing device.

### Example Application Programing Interfaces (APIs)

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

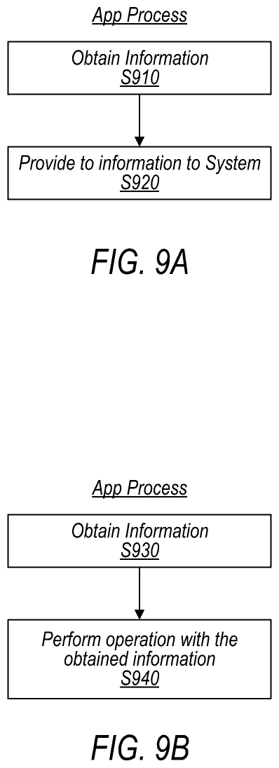

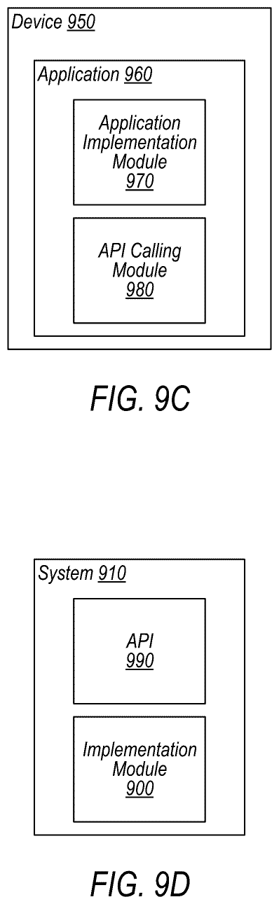

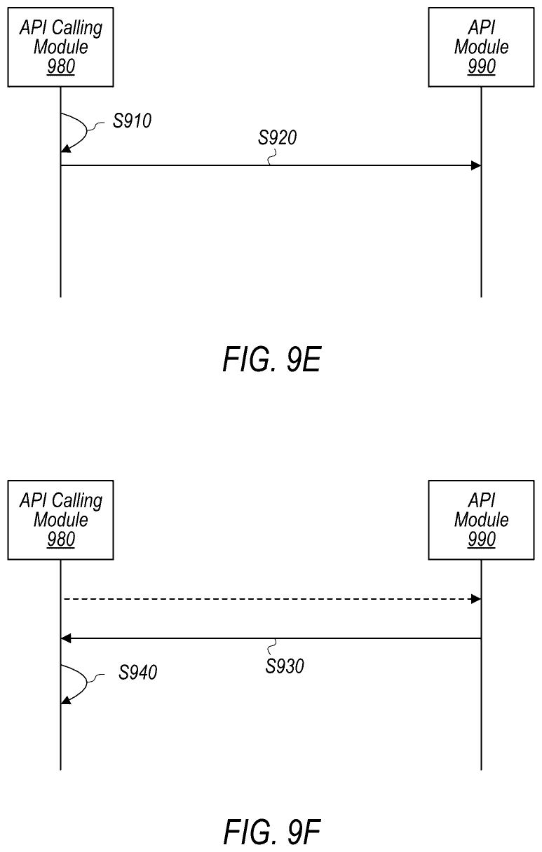

Implementations within the scope of the present disclosure include a computer-readable storage medium that encodes instructions organized as an application (e.g., application 960) that, when executed by one or more processing units, control an electronic device (e.g., device 950) to perform the method of FIG. 9A, the method of FIG. 9B, and/or one or more other processes and/or methods described herein.

It should be recognized that application 960 (shown in FIG. 9C) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 960 is an application that is pre-installed on device 950 at purchase (e.g., a first party application). In other embodiments, application 960 is an application that is provided to device 950 via an operating system update file (e.g., a first party application or a second party application). In other embodiments, application 960 is an application that is provided via an application store. In some embodiments, the application store can be an application store that is pre-installed on device 950 at purchase (e.g., a first party application store). In other embodiments, the application store is a third-party application store (e.g., an application store that is provided by another application store, downloaded via a network, and/or read from a storage device).

Referring to FIG. 9A and FIG. 9E, application 960 obtains information (e.g., at S910). In some embodiments, at S910, information is obtained from at least one hardware component of the device 950. In some embodiments, at S910, information is obtained from at least one software module of the device 950. In some embodiments, at S910, information is obtained from at least one hardware component external to the device 950 (e.g., a peripheral device, an accessory device, a server, etc.). In some embodiments, the information obtained at S910 includes positional information, time information, notification information, user information, environment information, electronic device state information, weather information, media information, historical information, event information, hardware information, and/or motion information. In some embodiments, in response to and/or after obtaining the information at S910, application 960 provides the information to a system (e.g., at S920).

In some embodiments, the system (e.g., system 910 shown in FIG. 9D) is an operating system hosted on the device 950. In some embodiments, the system 910 is an external device (e.g., a server, a peripheral device, an accessory, a personal computing device, etc.) that includes an operating system.

Referring to FIG. 9B and FIG. 9F, application 960 obtains information (e.g., at S930). In some embodiments, the information obtained at S930 includes positional information, time information, notification information, user information, environment information electronic device state information, weather information, media information, historical information, event information, hardware information and/or motion information. In response to and/or after obtaining the information at S930, application 960 performs an operation with the information (e.g., at S940). In some embodiments, the operation performed at $940 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 910 based on the information.

In some embodiments, one or more steps of the method of FIG. 9A and/or the method of FIG. 9B is performed in response to a trigger. In some embodiments, the trigger includes detection of an event, a notification received from system 910, a user input, and/or a response to a call to an API provided by system 910.

In some embodiments, the instructions of application 960, when executed, control device 950 to perform the method of FIG. 9A and/or the method of FIG. 9B by calling an application programming interface (API) (e.g., API 990) provided by system 910. In some embodiments, application 960 performs at least a portion of the method of FIG. 9A and/or the method of FIG. 9B without calling API 990.

In some embodiments, one or more steps of the method of FIG. 9A and/or the method of FIG. 9B includes calling an API (e.g., API 990) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 9C, device 950 is illustrated. In some embodiments, device 950 is a personal computing device, a smart phone, a smart watch, a fitness tracker, a head mounted display (HMD) device, a media device, a communal device, a speaker, a television, and/or a tablet. As illustrated in FIG. 9C, device 950 includes application 960 and operating system (e.g., system 910 shown in FIG. 9D). Application 960 includes application implementation module 970 and API calling module 980. System 910 includes API 990 and implementation module 900. It should be recognized that device 950, application 960, and/or system 910 can include more, fewer, and/or different components than illustrated in FIGS. 9C and 9D.

In some embodiments, application implementation module 970 includes a set of one or more instructions corresponding to one or more operations performed by application 960. For example, when application 960 is a messaging application, application implementation module 970 can include operations to receive and send messages. In some embodiments, application implementation module 970 communicates with API calling module to communicate with system 910 via API 990 (shown in FIG. 9D).

In some embodiments, API 990 is a software module (e.g., a collection of computer-readable instructions) that provides an interface that allows a different module (e.g., API calling module 980) to access and/or use one or more functions, methods, procedures, data structures, classes, and/or other services provided by implementation module 900 of system 910. For example, API-calling module 980 can access a feature of implementation module 900 through one or more API calls or invocations (e.g., embodied by a function or a method call) exposed by API 990 and can pass data and/or control information using one or more parameters via the API calls or invocations. In some embodiments, API 990 allows application 960 to use a service provided by a Software Development Kit (SDK) library. In other embodiments, application 960 incorporates a call to a function or method provided by the SDK library and provided by API 990 or uses data types or objects defined in the SDK library and provided by API 990. In some embodiments, API-calling module 980 makes an API call via API 990 to access and use a feature of implementation module 900 that is specified by API 990. In such embodiments, implementation module 900 can return a value via API 990 to API-calling module 980 in response to the API call. The value can report to application 960 the capabilities or state of a hardware component of device 950, including those related to aspects such as input capabilities and state, output capabilities and state, processing capability, power state, storage capacity and state, and/or communications capability. In some embodiments, API 990 is implemented in part by firmware, microcode, or other low level logic that executes in part on the hardware component.

In some embodiments, API 990 allows a developer of API-calling module 980 (which can be a third-party developer) to leverage a feature provided by implementation module 900. In such embodiments, there can be one or more API-calling modules (e.g., including API-calling module 980) that communicate with implementation module 900. In some embodiments, API 990 allows multiple API-calling modules written in different programming languages to communicate with implementation module 900 (e.g., API 990 can include features for translating calls and returns between implementation module 900 and API-calling module 980) while API 990 is implemented in terms of a specific programming language. In some embodiments, API-calling module 980 calls APIs from different providers such as a set of APIs from an OS provider, another set of APIs from a plug-in provider, and/or another set of APIs from another provider (e.g., the provider of a software library) or creator of the another set of APIs.

Examples of API 990 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a Wi-Fi™ API, a Bluetooth® API, an NFC API, a UWB API, a fitness API, a smart home API, contact transfer API, photos API, camera API, and/or image processing API. In some embodiments the sensor API is an API for accessing data associated with a sensor of device 950. For example, the sensor API can provide access to raw sensor data. For another example, the sensor API can provide data derived (and/or generated) from the raw sensor data. In some embodiments, the sensor data includes temperature data, image data, video data, audio data, heart rate data, inertial measurement unit (IMU) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 900 is a system (e.g., operating system, server system) software module (e.g., a collection of computer-readable instructions) that is constructed to perform an operation in response to receiving an API call via API 990. In some embodiments, implementation module 900 is constructed to provide an API response (via API 990) as a result of processing an API call. By way of example, implementation module 900 and API-calling module 980 can each be any one of an operating system, a library, a device driver, an API, an application program, or other module. It should be understood that implementation module 900 and API-calling module 980 can be the same or different type of module from each other. In some embodiments, implementation module 900 is embodied at least in part in firmware, microcode, or other hardware logic.

In some embodiments, implementation module 900 returns a value through API 990 in response to an API call from API-calling module 980. While API 990 defines the syntax and result of an API call (e.g., how to invoke the API call and what the API call does), API 990 might not reveal how implementation module 900 accomplishes the function specified by the API call. Various API calls are transferred via the one or more application programming interfaces between API-calling module 980 and implementation module 900. Transferring the API calls can include issuing, initiating, invoking, calling, receiving, returning, and/or responding to the function calls or messages. In other words, transferring can describe actions by either of API-calling module 980 or implementation module 900. In some embodiments, a function call or other invocation of API 990 sends and/or receives one or more parameters through a parameter list or other structure.

In some embodiments, implementation module 900 provides more than one API, each providing a different view of or with different aspects of functionality implemented by implementation module 900. For example, one API of implementation module 900 can provide a first set of functions and can be exposed to third party developers, and another API of implementation module 900 can be hidden (e.g., not exposed) and provide a subset of the first set of functions and also provide another set of functions, such as testing or debugging functions which are not in the first set of functions. In some embodiments, implementation module 900 calls one or more other components via an underlying API and thus be both an API calling module and an implementation module. It should be recognized that implementation module 900 can include additional functions, methods, classes, data structures, and/or other features that are not specified through API 990 and are not available to API calling module 980. It should also be recognized that API calling module 980 can be on the same system as implementation module 900 or can be located remotely and access implementation module 900 using API 990 over a network. In some embodiments, implementation module 900, API 990, and/or API-calling module 980 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

One example of an application (e.g., 960) is privacy protocol 150. In some embodiments, privacy protocol 150 is an application implementation module (e.g., 970) included in an application (e.g., 960). In some embodiments, privacy protocol 150 is an API calling module (e.g., 980) included in an application (e.g., 960). In some embodiments, privacy protocol 150 functions to allow application 960 to use a service provided by the server systems 120. In some embodiments, privacy protocol 150 functions to allow application 960 to use a service provided by the server systems 120 by using a service provided by a Software Development Kit (SDK) library. In other embodiments, application 960 incorporates a call to a function or method provided by the SDK library and provided by API 990 or uses data types or objects defined in the SDK library and provided by API 990.

In some embodiments, method 700 (as described with respect to FIG. 7A) is performed at a computing device (e.g., device 110 as described herein) via a system process (e.g., an operating system process, a server system process) that is different from one or more applications executing and/or installed on the first computer system.

In some embodiments, method 700 is performed at a computing device (e.g., device 110 as described herein) by an application that is different from a system process. In some embodiments, the instructions of the application, when executed, control the first computer system to perform method 700 by calling an application programming interface (API) provided by the system process. In some embodiments, the application performs at least a portion of method 700 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 700 by calling an application programming interface (API) provided by the system process using one or more parameters.

In some embodiments, exemplary APIs provided by the system process include one or more of: an LLM processing API, a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a Wi-Fi™ API, a Bluetooth® API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 990 defines a privacy protocol API call that can be provided by API calling module 990, wherein the definition for the API call specifies the following call parameters: encrypted information request(s) 160. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 950) that runs the application. In some embodiments, the implementation module is included in an electronic device that is separate from the device that runs the application.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript. An instance of a program being executed may be referred to as a “process.”

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., RAM). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

The present disclosure refers to various software operations that are performed in the context of any computing device that uses an operating system to run and schedule processes. Such a computing device can be configured according to any known configuration of computer hardware. A typical hardware configuration includes a processor subsystem, memory, and one or more I/O devices coupled via an interconnect. A given computing device may also be implemented as two or more computer systems operating together.

The processor subsystem of the computing device may include one or more processors or processing units. In some embodiments of the computing device, multiple instances of a processor subsystem may be coupled to the system interconnect. The processor subsystem (or each processor unit within a processor subsystem) may contain any of various processor features known in the art, such as a cache, hardware accelerator, etc.

The system memory of the computing device is usable to store program instructions executable by the processor subsystem to cause the computing device to perform various operations described herein. The system memory may be implemented using different physical, non-transitory memory media, such as hard disk storage, floppy disk storage, removable disk storage, flash memory, RAM (SRAM, EDO RAM, SDRAM, DDR SDRAM, RAMBUS RAM, etc.), read-only memory (PROM, EEPROM, etc.), and so on. Memory in the computing device is not limited to primary storage. Rather, the computing device may also include other forms of storage such as cache memory in the processor subsystem and secondary storage in the I/O devices (e.g., a hard drive, storage array, etc.). In some embodiments, these other forms of storage may also store program instructions executable by the processor subsystem.

The interconnect of the computing device may connect the processor subsystem and memory with various I/O devices. One possible I/O interface is a bridge chip (e.g., Southbridge) from a front-side to one or more back-side buses. Examples of I/O devices include storage devices (hard drive, optical drive, removable flash drive, storage array, SAN, or their associated controller), network interface devices (e.g., to a computer network), or other devices (e.g., graphics, user interface devices).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.”

Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a United States patent application based on this disclosure, it will recite claim elements using the “means for” [performing a function] construct.

What is claimed is:

1. A method, comprising:
receiving, at a computing device, a query, the computing device storing a query processing model;
sending, by the computing device to a server, one or more information requests based on the query, wherein a given information request is made according to one or more privacy protocols and is encrypted using a first cryptographic key that is not accessible by the server, such that a plaintext version of the given information request is also not accessible to the server;
receiving, by the computing device from the server, one or more information responses to the given information request, wherein a given one of the one or more information responses includes one or more response objects generated according to one of the one or more privacy protocols in a ciphertext space such that plaintext versions of the one or more response objects are not accessible to the server;
decrypting, by the computing device using a second cryptographic key, response objects that are received as part of the one or more information responses;
generating, by the computing device using the query processing model and the decrypted response objects, a result for the query; and
outputting, by the computing device, the result.

2. The method of claim 1, wherein the given information request includes a request embedding in an embedding space, and wherein corresponding response objects for the given information request include:
one or more neighbor embeddings of the request embedding; and
respective distances between the neighbor embeddings and the request embedding.

3. The method of claim 1, wherein the method further comprises sending one or more additional information requests to a different server, and the generating uses information received from the different server in response to the one or more additional information requests.

4. The method of claim 3, wherein the given information request is for a privacy-preserving Nearest Neighbor search protocol, and a given one of the additional information requests is for a privacy-preserving key-value protocol.

5. The method of claim 1, wherein the server is selected from a plurality of servers based on content of the query, and wherein the first cryptographic key is a public key of a key pair, and the second cryptographic key is a private key of the key pair.

6. The method of claim 1, further comprising dividing the query into a plurality of sub-queries, wherein the one or more information requests are based on a first of the plurality of sub-queries.

7. The method of claim 6, wherein generating the result for the query is also based on additional decrypted response objects corresponding to one or more remaining ones of the plurality of sub-queries, including additional decrypted response objects that are received from one or more of a plurality of servers that includes the server.

8. The method of claim 7, wherein generating the result for the query is also based on private user data received from a database that is local to the computing device.

9. The method of claim 7, wherein the additional decrypted response objects include objects received from multiple ones of the plurality of servers.

10. The method of claim 1, wherein the query is generated by a background process executing on the computing device without user input.

11. The method of claim 1, wherein the sending of the one or more information requests is further based on context information stored in the computing device, wherein the context information includes at least a current time and a current location of the computing device.

12. The method of claim 2, wherein the request embedding includes information identifying a particular item of multimedia content that is tuned based on context information indicating a portion of the particular item of multimedia content that a user of the computing device has already consumed.

13. A non-transitory, computer-readable storage medium storing program instructions executable by a computing device storing a query processing model to perform operations comprising:
receiving a query;
sending, to a server, one or more information requests based on the query, wherein a given information request is made according to one or more privacy protocols and is encrypted using a first cryptographic key that is not accessible by the server, such that a plaintext version of the given information request is also not accessible to the server;
receiving, from the server, one or more information responses to the given information request, wherein a given one of the one or more information responses includes one or more response objects generated according to one of the one or more privacy protocols in a ciphertext space such that plaintext versions of the one or more response objects are not accessible to the server;
decrypting, using a second cryptographic key, response objects that are received as part of the one or more information responses;
generating, using the query processing model and the decrypted response objects, a result for the query; and
outputting the result.

14. The computer-readable storage medium of claim 13, wherein the given information request includes a request embedding in an embedding space, and wherein corresponding response objects for the given information request include:
one or more neighbor embeddings of the request embedding; and
respective distances between the neighbor embeddings and the request embedding.

15. The computer-readable storage medium of claim 13, wherein the operations further comprise sending one or more additional information requests to a different server, and the generating uses information received from the different server in response to the one or more additional information requests, and wherein the given information request is for a privacy-preserving Nearest Neighbor search protocol, and a given one of the additional information requests is for a privacy-preserving key-value protocol.

16. The computer-readable storage medium of claim 13, wherein the operations further comprise dividing the query into a plurality of sub-queries, wherein the one or more information requests are based on a first of the plurality of sub-queries; and
generating the result for the query is based on:
additional decrypted response objects corresponding to one or more remaining ones of the plurality of sub-queries, including additional decrypted response objects that are received from one or more of a plurality of servers that includes the server; and
private user data received from a database that is local to the computing device.

17. A computing device, comprising:
a processor circuit; and
a memory storing:
a query processing model;
program instructions executable by the processor circuit to perform operations comprising:
receiving a query, the computing device;
sending, to a server, one or more information requests based on the query, wherein a given information request is made according to one or more privacy protocols and is encrypted using a first cryptographic key that is not accessible by the server, such that a plaintext version of the given information request is also not accessible to the server;
receiving, from the server, one or more information responses to the given information request, wherein a given one of the one or more information responses includes one or more response objects generated according to one of the one or more privacy protocols in a ciphertext space such that plaintext versions of the one or more response objects are not accessible to the server;
decrypting, using a second cryptographic key, response objects that are received as part of the one or more information responses;
generating, using the query processing model and the decrypted response objects, a result for the query; and
outputting the result.

18. The computing device of claim 17, wherein the given information request includes a request embedding in an embedding space, and wherein corresponding response objects for the given information request include:
one or more neighbor embeddings of the request embedding; and
respective distances between the neighbor embeddings and the request embedding.

19. The computing device of claim 17, wherein the operations further comprise sending one or more additional information requests to a different server, and the generating uses information received from the different server in response to the one or more additional information requests, and wherein the given information request is for a privacy-preserving Nearest Neighbor search protocol, and a given one of the additional information requests is for a privacy-preserving key-value protocol.

20. The computing device of claim 17, wherein the operations further comprise dividing the query into a plurality of sub-queries, wherein the one or more information requests are based on a first of the plurality of sub-queries; and
generating the result for the query is based on:
additional decrypted response objects corresponding to one or more remaining ones of the plurality of sub-queries, including additional decrypted response objects that are received from one or more of a plurality of servers that includes the server; and
private user data received from a database that is local to the computing device.
